(19) United States
(12) Patent Application Publication
(10) Pub. No.: US 2008/0289548 A1
(43) Pub. Date: Nov. 27, 2008

(54) Modular security suite [MSS] TM M.A.S.F.

(76) Inventor: Michael Delane Montaigne, Bixby, OK (US)

Correspondence Address: Michael Delane Montaigne, POB 1043, Bixby, OK, 74008-1043, US

(21) Appl. No.: 11/796,980

(22) Filed: Apr. 30, 2007

Related U.S. Application Data
(60) Provisional application No. 60/796,683, filed on May 2, 2006.

(51) Int. Cl. E05G 1/06

(52) U.S. Cl. 109/78

(57) ABSTRACT

A Modular Security Suite™ of rooms/modules is for the protection of families and/or valuable personal property during Earthquake related and other emergencies. The “Dual Use” space MSS model has two or more adjacent rooms or modules and an adjacent hallway module. One room could be a W.C. and the other module could be a kitchenette or pantry or walk-in high security storage room. Its steel walls and ceiling would be made with interior and exterior steel plates which are welded and/or otherwise fastened to its vertical and horizontal steel/stud pipes or I-beam/studs and then can be filled with concrete.

Thusly, the Modular Security Suite becomes a steel and concrete monolithic extension of the building's foundation. Moreover, the design's ship like steel bow/superstructure should resist earthquake related emergencies, flying debris and/or most types of ammo should an intruder invade a private home, bank, school or other building.

### BACKGROUND AND PRIOR ART

NOAA and other serve weather forecasters are predicting a cyclical increase in the number of hurricanes for the next ten years or so as well as those hurricanes are predicted to be more intense and damaging at least partially due to significant warming of the Gulf of Mexico, Atlantic Ocean waters and Hawaiian Islands. Similar finds are also being predicted globally. Furthermore, California has extreme annual canyon fire and brush fire risk as well as significant and increasing risk due to lack of movement of the San Andres and other related Earthquake faults.

In 2004 & 2005 Florida and the U.S. Gulf coast experienced a series of devastating hurricanes and associated tornadoes some of with were Hurricane Category 4 & 5. In may of 1999, an F-5 tornado was Doppler-radar clocked at 318 MPH just east of Oklahoma City, Okla.; a world record for surface wind speed. Therefore, a next generation design for safe rooms was needed to meet the personal security and/or irreplaceable private property needs of families and businesses.

The Modular Security Suite™ M.A.S.F. utility design is intended to significant boost home, office and school security but also to be “Dual Use” space that would get regular everyday use but could be converted for emergency use in seconds. Moreover, this next generation design should add significant value to homes and offices so equipped, should appraise higher than comparables without a Modular Security Suite and should help sellers reduce days on the market when selling a home with a “Security Suite™”.

Typically, other storm shelter and safe room designs know to the inventor are not “Dual Use” and are made of significantly less robust or strong materials. Many are intended for short stays and do not have either a W.C. or a kitchenette or food pantry. Only the MSS design has put forward adding a hallway modular which protects interior doors from storm debris and thusly significantly improves ones odds of easily exiting such a storm shelter or safe room when the danger has passed. Additionally, its vertical steel pipe “studs” will help protect families from fallen trees and optional water tight interior doors would “buy time” for escape via its ceiling escape hatch when water are rising outside.

### SUMMARY OF THE INVENTION

In summary, a Modular Security Suite is intended to add security and value to any building it is attached to or embedded within. It is furthermore intended to be reasonable comfortable for people and pets [when evacuation is impossible] during earthquake or canyon fire related emergencies or while local police remove intruders from a private home, a bank, a school, et al. And unlike an SUV or other new car a Modular Security Suite should appreciate with time and could become the most valued amenity for families in an era of more severe and more frequent hurricanes and tornadoes and more looting in the wake of disasters or large scale mandatory hurricane, etc. evacuations.

### DESCRIPTION OF PREFERRED EMBODIMENT

The MSS California/Hawaii model is 400 S.F. [two car garage sized] or larger in overall size and it would include W.C., kitchenette or pantry, master down bedroom or secure home office and hallway module with built-in bunk beds. Its interior and exterior steel plate walls would be about 0.25″ thick with welded vertical 3″ steel pipe or steel channel studs about every 2-3 foot within its steel wall system/concrete form. The two pocket doors at either end of the hallway module would be made like the steel & concrete walls or would be steel core with wood paneled exteriors. Each room or module would have at least two exits and one room would also have an optional pull-down set of steps for a third exiting via a ceiling emergency escape hatch. Once this basic MSS is installed, concrete added, fixtures added and the interior decoration is complete the “Dual Use” design would “disappear” into the home or office floorplan and would not be obvious to a casual visitor. Several larger and smaller “Security Suites” models would be offered for smaller and larger than average homes, etc.; i.e., individual architects, structural engineers and property owners would decide on exact wall thicknesses, size and types of building materials to be used, number and size of Modular Security Suite rooms, Etc.

### Addendum RE: 37 CFR 1.125(b)

To the best of my knowledge the attached substitute specification for this filing contains no new matter not previously included.

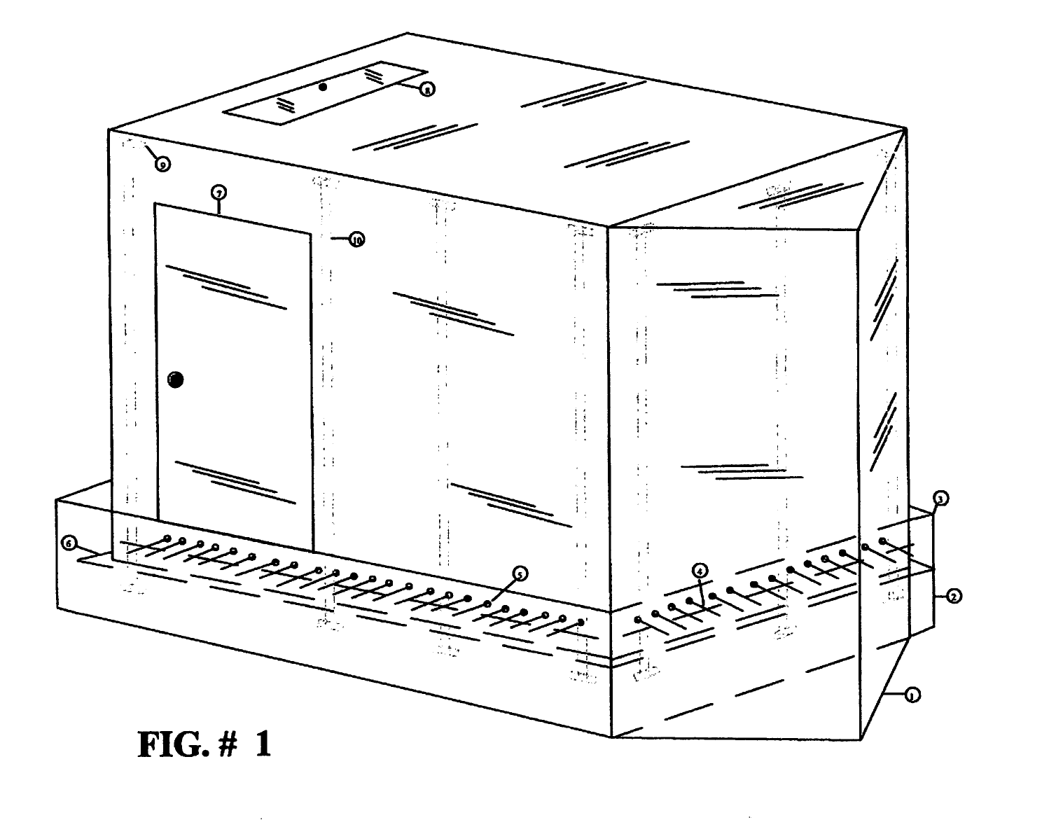

### FIG. 1 Explanation of Numbered Details

1) Concrete/steel or other materials are used to make the ship-bow-like “nose” of the MSS—Mud-Slide, Avalanche, (T)sunami, and Fire defense design.
2) Steel shell of MSS unit has steel pipe or other kinds of steel reinforced walls. The reinforcing elements have adjustable/threaded steel feet and similar steel caps. The adjustable feet help in installation and leveling before they are encased in poured foundation concrete and reinforcing re-rods.
3) Top edge of poured building foundation or floor level inside the MSS unit.
4) After re-rod passes through the MSS steel panel walls it is attached or welded to other similar re-rod normally found in concrete building foundations.
5) Holes are cut in the MSS steel shell wall through which the rerod for the main building foundation pass. Thusly, this locking means significantly increases wind-load tolerance during hurricanes, tornadoes and canyon fires.

### FIG. 1 Explanation of Numbered Details Continued

6) Steel panel sides to MSS unit extend deep into the building's foundation and are flared or bent outward to afford the MSS design more wind-load resistance and stability after these elements are covered with foundation concrete.
7) Each MSS unit will have at least two steel doors or sliding pocket doors will be F-5/C-5 wind load and debris impact rated.
8) Ceiling emergency escape hatch will also be F-5/C-5 wind & debris rated.
9) Steel cap on steel pipe or other interior structural support for MSS steel shell plates or wall system.
10) Steel pipe or other interior structural support for MSS steel shell plates with adjustable steel feet for leveling of MSS unit before installation of building's poured concrete foundation.

| | | |
|---|---|---|
| 4,126,972 | Nov. 28, 1978 | Silen |
| 5,979,128 | Nov. 09, 1999 | Parsons |
| 6,334,278 | Jan. 01, 2002 | Arnold |
| 6,393,776 | May 28, 2002 | Waller, et al |
| 6,415,558 | Jul. 09, 2002 | Cherry |

I claim:

1. A basic Modular Security Suite [MSS] {U.S. patent application Ser. No. 11/443,802} is composed of at least two modules or rooms and its purpose is to help protect people, pets, and personal property from hurricanes, tornadoes, intruders and other threats.
A MSS M.A.S.F would also have a W.C., kitchenette or pantry (with “Floating Wall™” for water storage and room size adjustments as needed), optional master down bedroom or room, an adjacent hallway module as well as ship-like steel bow or super-structure to help divert mudslides, avalanches, Etc. often occurring with earthquake activity. Such a suite of “Dual Use” rooms would get everyday foot traffic but could be converted for emergency use in seconds by closing its two steel or other material(s) pocket doors at either end of the hallway module.

2. The dual steel or other material(s) wall of an MSS with vertical steel pipe or I-beam “studs” provides families further protection when the steel plate walls and ceiling are filled with concrete [or water or sand, Etc.], rerod, conduits for power, ventilation, communication, et al. Its steel plate walls extend deep into it concrete or other material foundation and are anchored there by its “L” shaped steel “Foot”—lower bent outward end of all of its steel plate walls. Moreover, the steel reinforcement rods typically used in foundations are routed via holes in the in-foundation steel plate walls so as to significantly increase anchoring/fastening strength of M.A.S.F Modular Security Suites and other MSS models. Thusly the whole MSS design becomes “monolithic” and integrated when installed at the same time the concrete foundation for the home or other building is poured.

3. The often unused space above doorways and near ceilings is used in the MSS M.A.S.F. design for automatic/electrical or manual “pull-down” storage platforms or boxes which are supported by steel cable, nylon rope or other cable/line. Therein or thereon mattresses, medical supplies, food, water, business records, PCs or PC elements, Etc. could be stored or used or secured as needed. All rooms in this design would also be so designed for maximum space utilization, personal comfort, security and convenience.
